(19) United States
(12) Patent Application Publication
(10) Pub. No.: US 2011/0153563 A1
(43) Pub. Date: Jun. 23, 2011

(54) ENHANCED REPLICATION OF DATABASES

(75) Inventors: Annemarie R. Fitterer, Austin, TX (US); Ramakrishna J. Gorthi, Pune (IN); Chandrajit G. Joshi, Pune (IN); Romil J. Shah, Pune (IN)

(73) Assignee: International Business Machines Corporation, Armonk, NY (US)

(21) Appl. No.: 12/644,085

(22) Filed: Dec. 22, 2009

(51) Int. Cl. G06F 17/30; G06F 17/00

(52) U.S. Cl. 707/623; 707/626; 707/E17.032; 707/E17.005

(57) ABSTRACT

A server for replicating a database update operation. Responsive to an update request received at an supplier server that affects more than one database entry at the supplier server, a single replication request is built that contains an expression identifying the affected database entries to be replicated and the respective values of the entries to be replicated. The single replication request is transmitted to the consumer server.

### BACKGROUND OF THE INVENTION

This invention is related generally to the fields of networking, computing, and databases, and specifically to the replication of filtered database update modifications wherein multiple database entries are to be replicated . . . . The disclosure uses LDAP (Lightweight Directory Access Protocol) as an example. However, the principles of the specification can be extended in general to any database. The disclosed, illustrative embodiment is designed to execute on a computer such as a desktop, a workstation, a laptop or general-purpose mainframe, although alternative embodiments such as special-purpose electronics are possible. LDAP is an open industry standard defining a method for accessing and updating information in a directory. A directory server is an implementation of the LDAP protocol. It is basically a read-centric repository, wherein users can store any kind of data such as names and addresses, applications, files, printers, network resources etc. Data is stored in the directory servers in the form of tree entries. LDAP replications of multiple entries that are changed using query filters presently require a separate replication message for every changed entry.

### BRIEF SUMMARY OF THE INVENTION

A first embodiment of the invention is a method of replicating a database update operation. Responsive to an update request received at a supplier server that affects more than one database entry at the supplier server, a single replication request is built that contains an expression identifying the affected database entries to be replicated and the respective values of the attributes to be replicated. The single replication request is transmitted to the consumer server.

A second embodiment is a computer program product containing computer program code for replicating a database update operation. The computer program product has computer usable program code embodied therewith. The computer usable program code is configured to build a single replication request containing an expression identifying the affected database entries to be replicated to a consumer server and the respective values of the attributes to be updated. The supplier server also contains computer usable program code configured to transmit the single replication request to the consumer server.

A third embodiment is an update database server. The database server contains computer program code responsive to an update request received at the supplier server that affects more than one database entry at the supplier server for building a single replication request. The single replication request contains an expression identifying the affected database entries at a consumer server to be replicated and the respective values of the attributes to be replicated. The supplier server also contains computer program code for transmitting the single replication request to the consumer server.

### BRIEF DESCRIPTION OF THE SEVERAL VIEWS OF THE DRAWINGS

In the drawings:

FIG. 1 shows an illustrative block diagram of a system, including a supplier server for performing database update operations and a consumer server for replicating selected updates that have been performed on the supplier server;

FIG. 2 is an example of an LDAP database;

FIG. 3 is a flowchart showing steps that an supplier server might perform in serving an update request and in requesting a replication operation in a consumer server;

FIG. 4 shows steps that might be performed in a replication thread of an supplier server; and

FIG. 5 shows steps that might be performed at a consumer server in response to the receipt of a replication request message from the supplier server.

### DETAILED DESCRIPTION OF THE INVENTION

As will be appreciated by one skilled in the art, the present invention may be embodied as a method, system, or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product on a computer-usable storage medium having computer-usable program code embodied in the medium.

Any suitable computer usable or computer readable medium may be utilized. The computer-usable or computer-readable medium may be, for example but not limited to, an electronic, magnetic, optical, electromagnetic, infrared, or semiconductor system, apparatus, device, or propagation medium. In many environments, there can be computer storage or propagation media at both server and client, and software at the server that embodies the invention can be downloaded to a client for execution. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to the Internet, wireline, optical fiber cable, RF, etc.

Computer program code for carrying out operations of the present invention may be written in an object oriented programming language such as Java, Smalltalk, C++ or the like. However, the computer program code for carrying out operations of the present invention may also be written in conventional procedural programming languages, such as the “C” programming language or similar programming languages. The program code may execute entirely on the designer's computer, partly on the designer's computer, as a stand-alone software package, partly on the designer's computer and partly on a remote computer or entirely on the remote computer or server. In the latter scenario, the remote computer may be connected to the designer's computer through a local area network (LAN) or a wide area network (WAN), or the connection may be made to an external computer (for example, through the Internet using an Internet Service Provider).

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

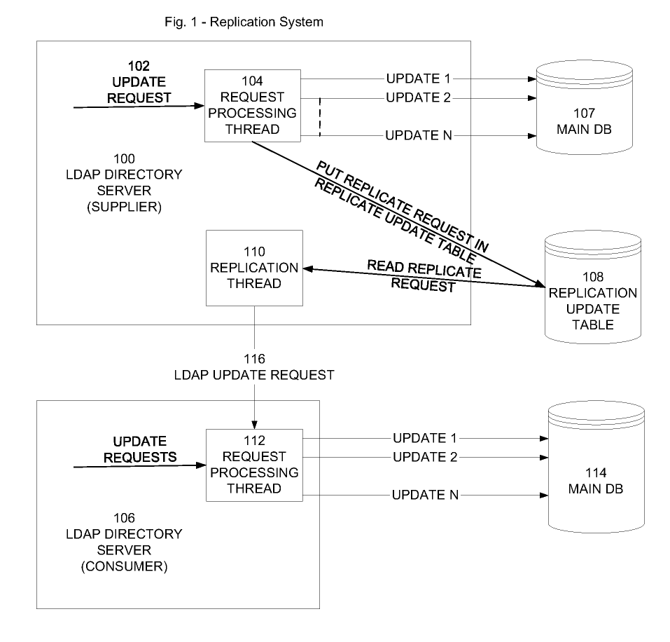

With reference now to FIG. 1, there is shown a simplified representation of a system for replicating database entries in a LDAP system. Server 100 is an LDAP server that contains a domain of database entries that are replicated to consumer server 106. There can be many configurations of a replication topology between servers. For example, servers 100 and 106 could be peer masters. In a peer master network comprising two directory servers, both servers operate as a consumer server for the other server. For illustration, it is assumed that both servers in FIG. 1 support the LDAP filtered modification operation in conformance with the Internet Engineering Task Force (IETF) Draft located at ttp://www.tools.ietf.org/html/draft-haripriya-ldapext-entryselect-00

At server 100 (the supplier), database update requests 102 arrive at server 100 and are entered into a request processing thread 104. In this illustrative embodiment of the invention, request processing thread 104 processes a modification request normally according to the LDAP protocols described in IETF RFCs 4511 et seq and updates the main database 107. If a filtered modification is performed at server 100 according to a query operation that affects multiple entries in the main database 107, the processing thread 104 builds a single replicate request and places the request in a replication update table 108. If the replication request affects only one entry at server 106, replication proceeds conventionally by placing that single entry request into replication update table 108. Periodically a replication thread 110 at server 100 fetches replication requests from table 108 and uploads the requests to the consumer server 106. These replication requests are inputted to the request processing thread 112 at server 106 via a separate link shown at 116 of FIG. 1. Request processing thread 112 at server 106 constructs an update request from the replicate request that is equivalent to the original update request received at 102 and updates its main database 114 in a conventional manner. Only the single modification request with entry select filter is replicated to server 106 instead of a series of updates messages each of which affect only one entry, as in the prior art. In accordance with the invention, a replication operation is performed independently at the consumer server in a way functionally identical to the way it is performed at the supplier server.

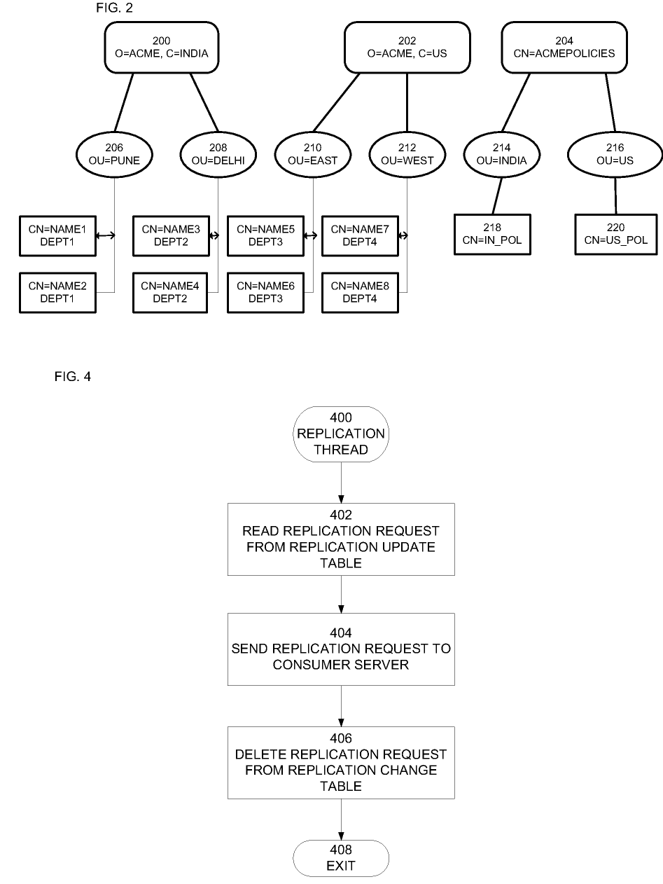

FIG. 2 shows an example of a database for a fictitious company Acme Corp. as an aid in describing the invention. Acme has offices in Pune and Delhi, India and offices on the east and west coast of the U.S.A. Database tree beginning with node 200 contains employee entries (employee name and department number) for India. Node 206 contains employee entries for Pune and node 208 contains entries for Delhi. Beginning node 202 contains similar employee names and department numbers for the U.S.A. offices. The tree beginning at node 204 contains corporate policy documents. Because the corporate policies are different between India and the U.S.A, separate documents are in the tree at leaf nodes 218 (document IN_POL) and 220 (document US_POL). In FIG. 2, the following attributes are standard in LDAP and have the following meanings: O=Organization, C=Country, OU=Organizational Unit, CN=Common Name. In FIG. 2, the top-level entry at 200 defines an LDAP Distinguished Name (DN) as the attribute O=ACME, C=INDIA. Child entries 206 and 208 define the attributes “OU=PUNE” AND “OU=DELHI”, respectively. The child nodes of nodes 206 and 208 contain the names of employees at the respective Organizational Unit and their department numbers. Similarly, top-level node 202 and its children define the organizational units on the east and west coast of the U.S.A. and their respective employees and department numbers. Top-level entry 204 contains the attribute “CN=ACMEPOLICIES”.

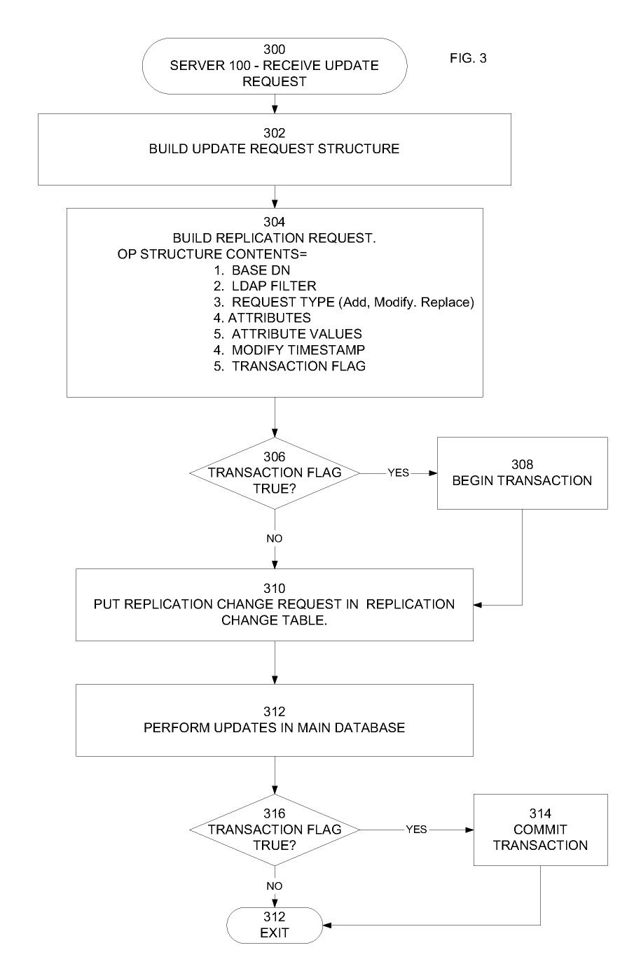

FIG. 3 shows a flowchart of steps performed at supplier server 100 to begin replication in response to a update request. The process begins at 300 in response to arrival of an update request.

As an example, the following shows an update request from a client to change the Department numbers of all employees at the Delhi, India office to “DEPT1”.

idsldapmodify-p<port>-D<adminDN>-w<password>

dn: o=Delhi,c=India

filter: objectclass=person

changetype: modify

replace: dept

dept: DEPT1

Step 302 analyzes the request, builds an update stricture at step 302, request and executes the request locally at server 100. The following is a local update request that might be built by server 100 in response to the client request above.

Base DN: o=Delhi,c=India

Filter: objectclass=person

Modify type: replace

Attribute: dept

Value: DEPT1

Step 304 of FIG. 3 builds a replicate request. A replicate request typically contains a base DN and LDAP filter for locating the correct entries at consumer server 102. In addition, the request might include attributes and attribute values that are needed to perform updates, a modification timestamp and a boolean transaction flag. The boolean transaction flag, if true, represents an operation that might affect multiple entries, but can be rolled back as a whole if any part of the transaction fails. The use of the transaction flag is governed by IETF Draft by Kurt Zeilenga, dated Jun. 25, 2006 and entitled “LDAP Tranactions”. This Draft is located at URL http://tools.ietforg/html/draft-zeilenga-ldap-txn-08.

The following is an illustrative example of a replicate request, using the above example.

Base DN: o=Delhi,c=India

Filter: objectclass=person

Modify type: replace

Attribute: dept

Value: DEPT1

Timestamp: <op timestamp>

Transaction Flag: true

Step 306 determines if the Transaction flag is true in a replicate request. If Transaction Flag is True, then step 308 sets a marker to begin the processing of the transaction and then step 310 is executed. If Transaction Flag is False, then step 310 is entered without marking a transaction. In both cases, a single replication request message is placed in the replication update table 108 at step 310. Server 100 then executes the request locally at step 312. At step 316, if the Transaction Flag is true, and assuming no failures have occurred, then step 314 commits the transaction and this operation is ended at 312. In the meantime, the replication thread 110 of the server 100 pushes this single replication request message into the request processing thread 112 of consumer server 106.

On receiving the single replication request message, consumer server 106 performs an update operation using the details in the single replication request message in the same manner as that of the server 100. Server 106 also applies the same timestamp that is received in the single replicate request message to each entry being modified at consumer server 106. This ensures that the timestamp of all the modified entries will be same on both server 100 and the consumer server 106. This avoids replication conflicts arising out of timestamp mismatches. Note that if the transaction flag indicates that the operation was performed on the server 100 server as a transaction, consumer server 106 will also perform it as a transaction.

FIG. 4 shows illustrative steps that might be executed by replication thread 110 at sever 100. Step 402 periodically reads requests from the replication update table 108. Step 404 sends any request found at step 402 to the consumer server 106. Step 406 then deletes the sent requests from update table 108.

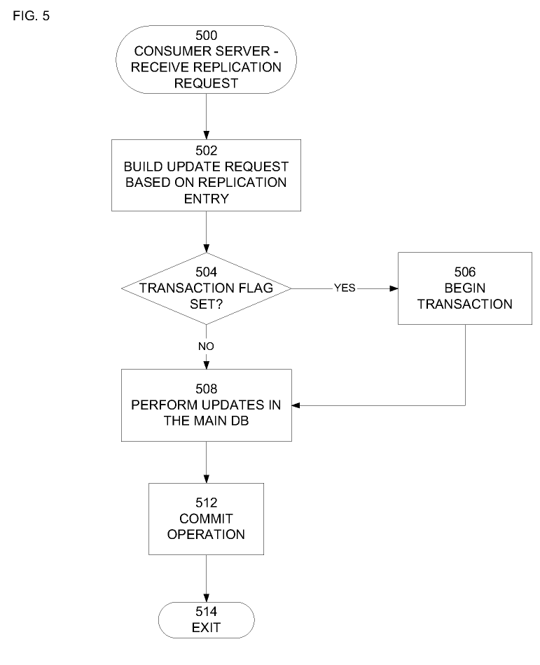

FIG. 5 shows illustrative steps that might be executed at consumer server 106 in response to a receipt of a replication request message from server 100. At step 502, server 106 builds an update request in much the same manner as step 304 in server 100. Step 504 determines if the transaction flag is set to “True”. If so, the transaction is begun at step 506 and the update operations are performed at step 508 in the main database at the consumer server. If the Transaction Flag is “False”, step 508 is performed without regard to a transaction. Step 512 then commits the replication updates to complete the processing of the replication request.

There are two special cases to be handled:

If the operation to be performed by the supplier server 100 affects only entries that are not under the replication context, then the operation will not be replicated to the replication server 106. If the update request from a client contains a null DN, which means that the operation is to be performed on all the trees in the server 100, then the replication is performed for only those suffixes that are defined to be within replication contexts. In this case, the server 100 will place as many replication request messages in the replication update table 108 as there are replication contexts.

Here is an example of the second special case. Remember that supplier server 100 hosts three trees—“O=ACME,C=INDIA”, “O=ACME,C=USA”, “CN=ACMEPOLICIES”. Also assume that replication is setup between server 100 and consumer server 106 for “O=ACME,C=INDIA” and “CN=ACMEPOLICIES”. Now assume that a filtered update operation is received by server 100 with the following parameters:

Base DN: ″″

Filter:Objectclass=person

Modify type: replace

Attribute:DepartmentNumber

Value: DEPT1

On the server 100 side, this operation would be performed on all the three trees. Since the replication is setup for only “O=ACME,C=IN” and “CN=ACMEPOLICIES”, it cannot be performed on NULL DN in consumer server 106. So supplier server 100 sends the following two messages to consumer server 106 for replication:

### Replication Entry1

Base DN: o=acme,c=india

Filter: objectclass=person

Modify type: replace

Attribute: departmentNumber

Value: DEPT1

Timestamp: <op timestamp>

TransactionFlag: true

### Replication Entry2

Base DN: cn=ACMEPolicies

Filter: objectclass=person

Modify type: replace

Attribute: departmentNumber

Value: DEPT1

Timestamp: <op timestamp>

TransactionFlag: true

On consumer server 106, two different filtered update operations are performed—one on “O=IBM, C=INDIA” and other on “CN=IBMPOLICIES”.

There are two error scenarios to consider:

1. Operation is performed as a transaction: If a filtered update is being performed as a transaction, then the sequence of steps to be followed would be:

Begin the database transaction.

Put the replication entry in the replication update table.

Perform the filtered modification op.

Commit the database transaction.

Replication thread 110 of the server 100 is able to select the replication request from table 108 only after the transaction is committed. Now assume that there is an error while performing the update operation. In this case the entire operation is rolled back. So nothing is replicated to the replication server 106.

2. The operation is not performed as a transaction: An option can be given to users to specify the maximum number of errors that can be tolerated while the operation is being performed. If errors are encountered, server would ignore them until the maximum number of errors is reached. There are two scenarios to be considered:

a) If the user has specified NumMaxErrors, then the server 100 would first put the replication update request in the replication update table 108. NumMaxErrors would be part the of the replication request. If there are any errors while server 100 is performing the update, it will continue until the NumMaxErrors is reached. Since the replication request was put in the table 108 in advance, replication server 106 would perform the update in parallel. Server 106 would adopt the same strategy as that of the server 100 while tolerating the errors. Synchronization of data in the two servers would not be ensured.

b) If the user has not specified NumMaxErrors, this means that the user wants to stop the processing at the first error. The replication request is put in the table 108 and the update is performed. If an error is encountered, processing is stopped. This will be true for both supplier server 100 as well as consumer server 106.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Having thus described the invention of the present application in detail and by reference to preferred embodiments thereof, it will be apparent that modifications and variations are possible without departing from the scope of the invention defined in the appended claims.

What is claimed is:

1. A method of replicating a database update operation, comprising
responsive to an update request received at a supplier server that affects more than one database entry at the supplier server, building a single replication request containing an expression identifying the affected database entries to be replicated to the consumer server and the respective values of the attributes of the entries, and transmitting the single replication request to the consumer server.

2. The method of claim 1 further comprising
updating the database entries at the consumer server identified by the expression.

3. The method of claim 1 further comprising
determining if the update request affects all entries at the supplier server, and
if so, determining which of the updated entries are defined to be replicated to the consumer server, and
transmitting a single replication request to the consumer server for all of the updated entries that are defined to be replicated to the consumer server.

4. The method of any of claims 1 through 3, wherein the supplier server utilizes LDAP (Lightweight Directory Access Protocol).

5. A computer program product for replicating a database update operation, the computer program product comprising:
a computer usable medium having computer usable program code embodied therewith, the computer usable program code comprising:
computer usable program code configured to build a single replication request containing an expression identifying the affected database entries to be replicated to a consumer server and the respective values of the attributes of the entries; and
computer usable program code configured to transmit the single replication request to the consumer server.

6. The computer program product of claim 5 further comprising
computer usable program code configured to update the database entries at the supplier server.

7. The computer program product of claim 5 further comprising
computer usable program code configured to determine if the update request affects all entries at the supplier server,
computer usable program code configured to determine which of the updated entries are defined to be replicated to the consumer server, and
computer usable program code configured to transmit a single replication request to the consumer server for all of the updated entries that are defined to be replicated to the consumer server.

8. The computer program product of claim 5 wherein the computer usable program code utilizes LDAP (Lightweight Directory Access Protocol).

9. The computer program product of claim 5, wherein the program code are stored in a computer readable storage medium in a data processing system, and wherein the instructions are downloaded over a network from a remote data processing system.

10. The computer program product as described in claim 5, wherein the instructions are stored in a computer readable storage medium in a server data processing system, and wherein the instructions are downloaded over a network to a remote data processing system for use in a computer readable storage medium with the remote system.

11. An update database server, comprising
computer program code responsive to an update request received at a supplier server that affects more than one database entry at the supplier server for building a single replication request containing an expression identifying the affected database entries at a consumer server to be replicated and the respective values of the entries to be replicated, and
computer program code for transmitting the single replication request to the consumer server.

12. The update database server of claim 11 further comprising
computer program code for updating the database entries at the supplier server.

13. The update database server of claim 11 further comprising
computer program code for determining if the update request affects all entries at the supplier server, and
computer program code for determining which of the updated entries are defined to be replicated to the consumer server, and
computer program code for transmitting a single replication request to the consumer server for all of the updated entries that are defined to be replicated to the consumer server.

14. The update database server of any of claims 11 through 13, wherein the computer program code servers utilize LDAP (Lightweight Directory Access Protocol).

15. The update database server of claim 11 wherein the computer program code for building a single replication request further comprises
a request processing thread for
receiving an update request for a database,
updating the database,
determining if the update request affects more than one database entry, and generating a single replication request that identifies all database entries to be replicated, and a replicating thread for transmitting the update request to a consumer server.

16. The update database server of claim 15 further comprising
a replication thread for transmitting a single replication request to the consumer server for all of the updated entries that are defined to be replicated to the consumer server.
